(19) United States
(12) Patent Application Publication
(10) Pub. No.: US 2002/0161706 A1
(43) Pub. Date: Oct. 31, 2002

(54) Method for presenting account information to a user

(76) Inventors: Ed Brinskele, Nicasio, CA (US); Michael Deutch, San Rafael, CA (US)

Correspondence Address: Finnegan, Henderson, Farabow,, Garrett & Dunner, L.L.P., 1300 I Street, N.W., Washington, DC, 20005-3315, US

(21) Appl. No.: 10/128,488

(22) Filed: Apr. 24, 2002

Related U.S. Application Data
(60) Provisional application No. 60/285,995, filed on Apr. 25, 2001.

(51) Int. Cl. G06F 17/60

(52) U.S. Cl. 705/41

(57) ABSTRACT

A user interface and related methods enable a customer to manage multiple products and/or multiple providers for multiple locations via a single account statement. A graphical user interface consistent with the present invention presents the account statement as a “dashboard” view of a customer's account activities. The dashboard view presents account information across multiple products and/or multiple providers. The present invention also provides a simple way for a customer to navigate from this high level of detail into more specific account information for a given product and/or provider.

### BACKGROUND OF THE INVENTION

A. Field of the Invention

The present invention relates to a graphical user interface for presenting account information to a customer. More particularly, the present invention relates to a graphical user interface for presenting information about the customers accounts with multiple vendors.

B. Description of the Related Art

Consumers and businesses today employ a variety of devices and services to meet their needs. For example, a typical telecommunications customer (i.e., a consumer or a business) may procure products from a number of different sources. For example, an individual consumer might subscribe to one provider for long distance service, another for cellular service, and a third for calling card service. A business with more diverse needs might have separate providers for toll free service, metrolink, T1 lines, frame relay service, etc.

In these typical situations, a customer must maintain a relationship with each provider. Initially, the customer obtains a product from the provider, for example, by purchasing a cellular phone or subscribing to a long distance service. The provider then establishes an account for the customer and sends account information, e.g., invoices, order status updates, etc., to the customer. Usually the customer pays the provider for the product on a periodic basis and communicates with the provider to submit repair requests, service change requests, or cancellation notices.

For many customers, maintaining relationships with multiple providers is time-consuming and confusing. Many businesses have one or more full-time employees dedicated to managing telecommunications products. To track telecommunications costs, a typical telecommunications manager must collect account information from a multitude of providers and perform complicated accounting tasks. To keep pace with a growing business's telecommunications needs, the telecommunications manager must frequently contact different providers to initiate or cancel service as employees join and leave the business. To ensure that service is not disrupted, the telecommunications manager must monitor all of the various providers in order to request repairs or make alternative arrangements when necessary.

To reduce the burden of managing telecommunications products, many providers implement user interfaces using the World Wide Web. These interfaces enable a customer to view account information instantly and to communicate with the provider electronically. While this simplifies the interaction with a single provider, the customer must still interact with multiple providers to fulfill all of his telecommunications needs.

For example, a cellular phone provider might offer a website enabling a customer to view his cellular phone account, but the customer must go to a different provider's website for detail on his data networks or long distance service. Similarly, a national or international business might have several cellular phone providers in different geographical areas. In this case, the telecommunications manager for the business must look at several different cellular phone provider websites in order to get a good picture of just the business's cellular costs. Even if a customer has only a single account with a single provider, to fully view the account information on a website, the customer must page or click through several different levels of detail or perform complicated accounting tasks.

It is therefore desirable to develop a method that enables a customer to manage information about multiple products, such as telecommunication products, via a single user interface. It is also desirable to enable the customer to manage information from multiple providers via a single user interface.

### SUMMARY OF THE INVENTION

Methods consistent with the present invention provide account information to a customer having a hierarchy of accounts and using a browser running on a client computer. For each of a plurality of providers, product information relating to a product provided by the provider to the customer is collected. When a request is received from the browser for a document containing information about a set of products provided to the customer corresponding to a designated account or accounts, the product information relating to the set of products is combined to create an account statement for the customer, and the document containing the account statement is displayed on the client computer.

Consistent with the present invention, a user interface is provided for presenting account information to a customer. The user interface, presented to a customer using a client computer running a browser, includes ten components. A first component includes account alerts corresponding to one or more products provided to the customer by one of a plurality of providers. A second component includes a set of account snapshots for presenting data about the customer's one or more products. A third component includes a summary of account trends indicating current and prior costs corresponding to the customer's one or more products. A fourth component includes a list of the customer's one or more products. A fifth component includes a list of service requests for one or more of the customer's products and the status of each of the listed service requests. A sixth component includes a drop down list enabling the customer to select a subset of the customer's products. A seventh component includes one or more drop down lists enabling the customer to select a new user interface to be displayed. An eighth component enables the customer to search the user interface. A ninth component includes a billing overview for the customer's one or more products. A tenth component includes contact information for the customer's service representatives. An eleventh component includes news items related to the customer's one or more products.

Another aspect of the invention provides a method for presenting telecommunications account information to a customer. For a plurality of telecommunications products, a request for a telecommunications product is received from the customer and sent to one of a plurality of providers for provision of the telecommunications product. Product information relating to the telecommunications product is collected from the provider of the telecommunications product. The product information relating to the plurality of communications products is combined to create an account statement for the customer, and the account statement is displayed to the customer.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate one embodiment of the invention and together with the description, serve to explain the principles of the invention.

In the drawings:

FIG. 1 is a representation of the logical architecture of a system consistent with the present invention;

FIG. 2 depicts a distributed system suitable for practicing methods and systems consistent with the present invention;

FIG. 3 is a block diagram showing server computer in more detail;

FIG. 4 depicts a user interface for presenting account data to a customer consistent with the present invention;

FIG. 5 is a sample user interface depicting a total expense trend report consistent with the present invention;

FIG. 6 shows account alerts, which can be accessed when the customer selects the account alerts section of the user interface shown in FIG. 4.

FIG. 7 is a detailed news page presented when a customer clicks on a title in the news section of the user interface of FIG. 4; and

FIG. 8 is a user interface for enabling a customer to personalize the appearance of the user interface of FIG. 4.

### DETAILED DESCRIPTION

A. Introduction

Consistent with the present invention, a method is provided to enable a customer to manage multiple products and/or providers, such as telecommunications products and/or providers, via a single user interface. A graphical user interface (GUI) consistent with the present invention presents a “dashboard” view of a customer's telecommunications account activities via a computer or wireless device. This dashboard view presents account information across multiple products and/or providers. The present invention also provides a simple way for a customer to navigate from this high level of detail into more specific account information for a given product and/or provider.

Methods consistent with the present invention enable a customer to log in to a website and instantly determine the status of all of his telecommunications accounts. The customer can see how much is being spent, what the trends are, what the service inventory looks like across all providers, the status of any add/change/remove orders, and so forth. From any point on the initial dashboard view, the customer can quickly and easily obtain more detail by using, for example, hyperlinks or drop-down lists.

The account information presented can support multiple customer locations, multiple providers, and multiple products to become a single point of contact for telecommunications management. The products can include, for example, devices, services, hardware, and software. The products can be communications products, including Internet-based products.

B. Detailed Description of the Drawings

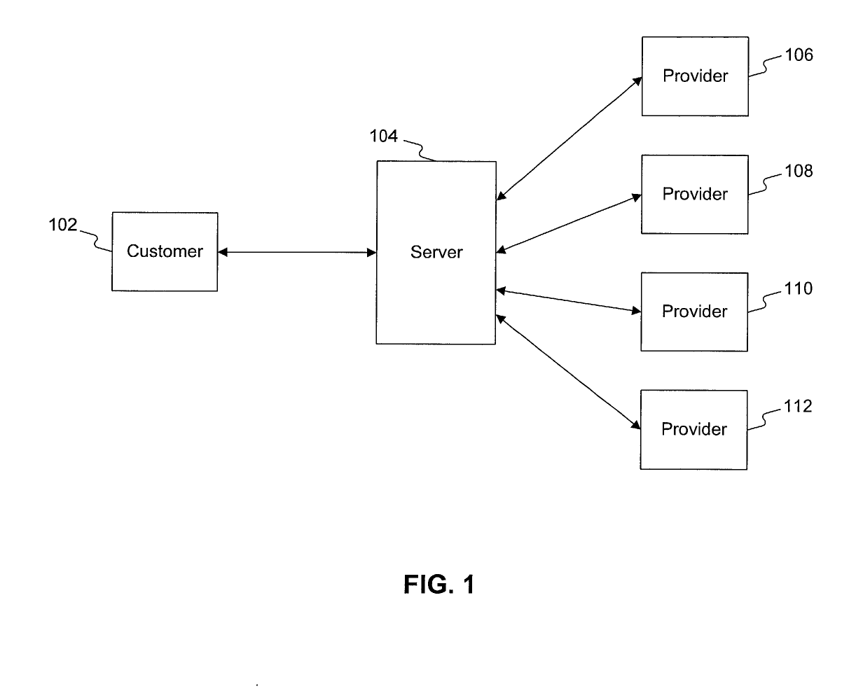

FIG. 1 is a representation of the logical architecture of a system consistent with the present invention. As shown in FIG. 1, a customer 102 communicates with a plurality of providers through a server 104. For instance, customer 102 may have one or more accounts with one or more providers, e.g., provider 106, provider 108, provider 110, and provider 112. To obtain data about the customer's accounts with each of the providers, customer 102 communicates with a single source, i.e., server 104.

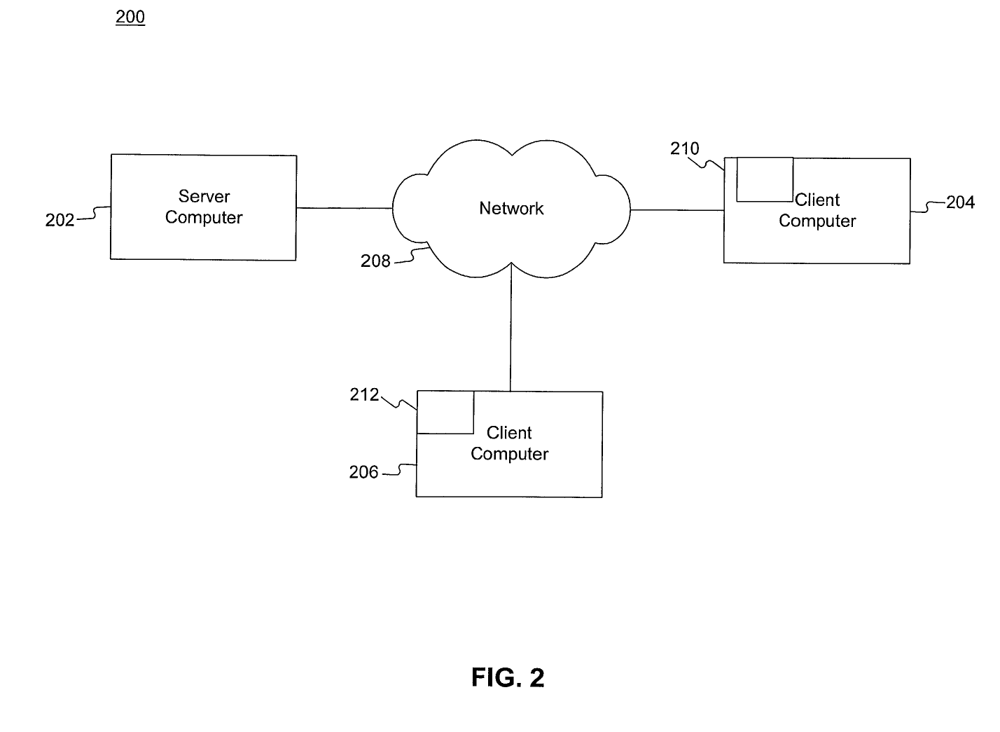

FIG. 2 depicts a distributed system 200 suitable for practicing methods and systems consistent with the present invention. Distributed system 200 includes a plurality of computers 202, 204, and 206, communicating via a network 208. Network 208 may be a local area network, wide area network, or the Internet. Client computers 204 and 206 run browser software 210 and 212, respectively, for accessing remote server computer 202 via network 208. Browser software 210 and 212 may be, for example, Microsoft Internet Explorer or Netscape Navigator. While distributed system 200 is shown to include client computers 204 and 206, any number of client computers can be utilized consistent with the present invention. Similarly, more than one server computer 202 may be utilized consistent with the present invention. Alternatively, customer 102 can use a wireless device, such as a wireless phone, pager, or personal digital assistant, to communicate with server 104 using a wireless protocol such as Wireless Application Protocol (WAP).

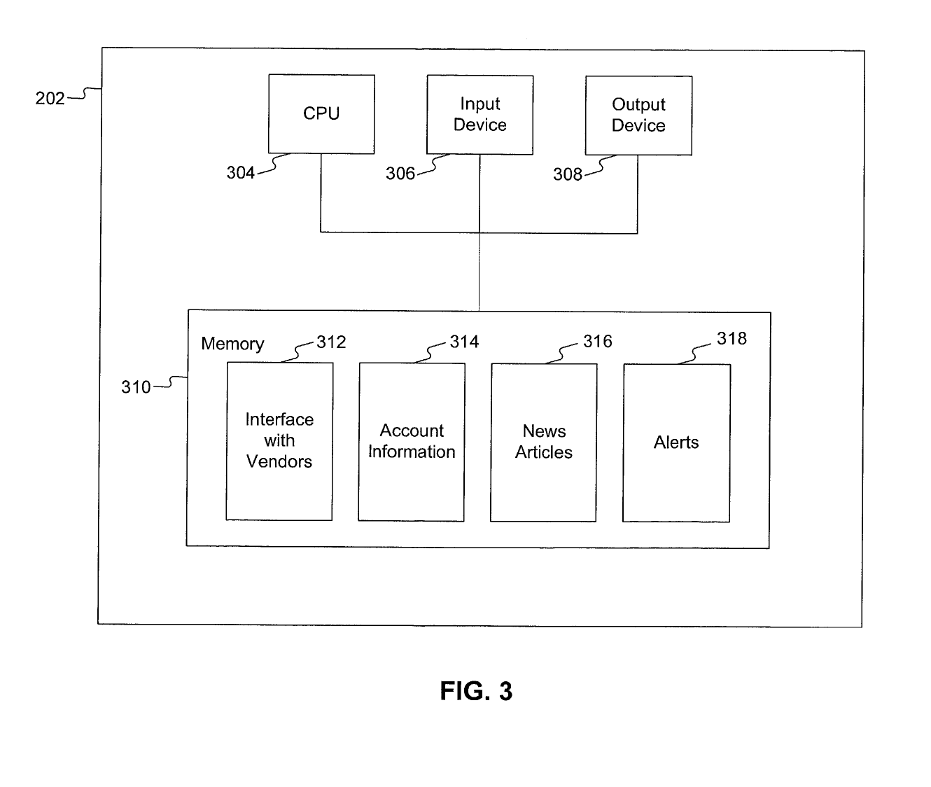

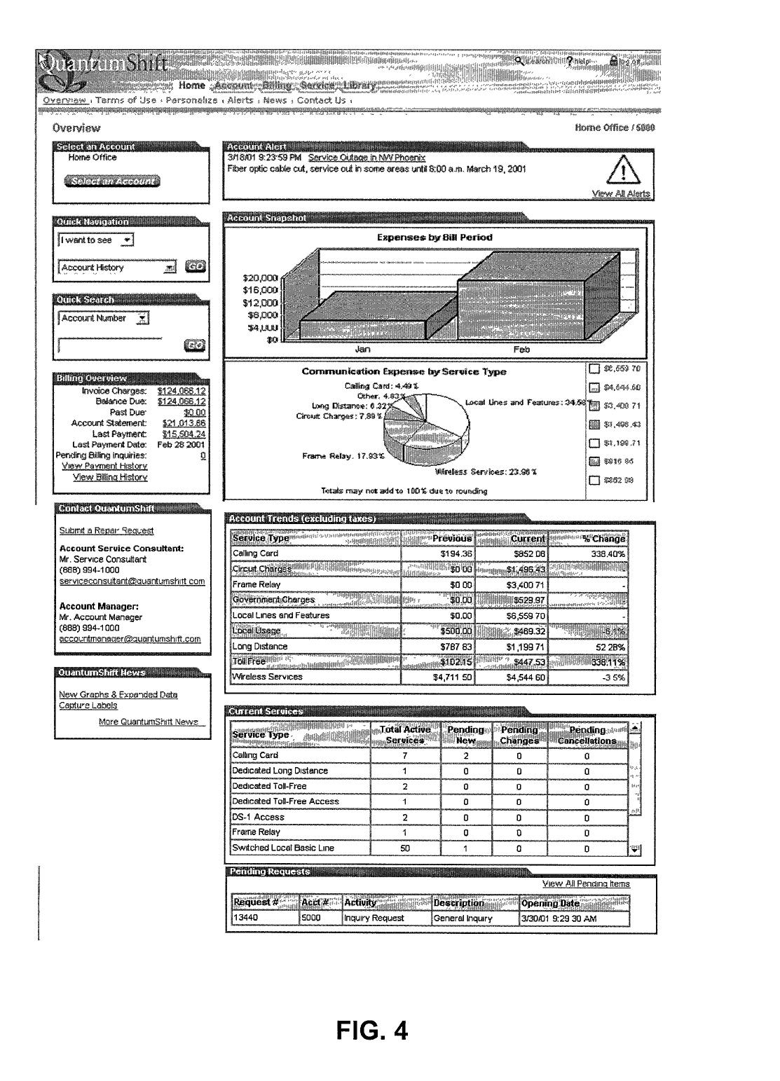

FIG. 3 is a block diagram showing server computer 202 in more detail. Server computer 202 includes a central processing unit (CPU) 304, an input device 306, an output device 308, and a memory 310. Input device 306 can be, for example, a keyboard or a mouse. Output device 308 can be, for example, a video display or a printer. Memory 310 can be, for example, random access memory or an external storage medium such as a magnetic or optical disk or CD-ROM. As shown, memory 310 can include an interface with vendors 312, account information 314, news articles 316, and alerts 318. The data stored in memory 310 is used by server computer 202 to create the user interfaces described below with reference to FIGS. 4-8.

FIG. 4 depicts a user interface for presenting account data to a customer consistent with the present invention. If the customer is using browser 210 on client computer 204, the account data can be in a document with text and fields for the user to interact with. The document can be, for example, in HTML or ASP. The account data presented is a package of information giving the customer, such as a telecommunications manager, a quick view of account information for multiple customer locations, multiple providers, and/or multiple products. As shown in FIG. 4, the account data includes a number of data fields or sections including: account alert, account snapshot, account trends, current services, pending requests, select an account, quick navigation, quick search, billing overview, contact information, and news. A user interface consistent with the present invention could also include a subset of these data fields.

The account alert section enables a customer to see information that affects the customer's products. The alert information can be based on geography, product type, supplier, etc. For example, if Worldcom in San Francisco is down, the server can post an alert in the account alert section for each customer receiving service from Worldcom in San Francisco. The alert can also include data about expected repair time, re-routing options, etc.

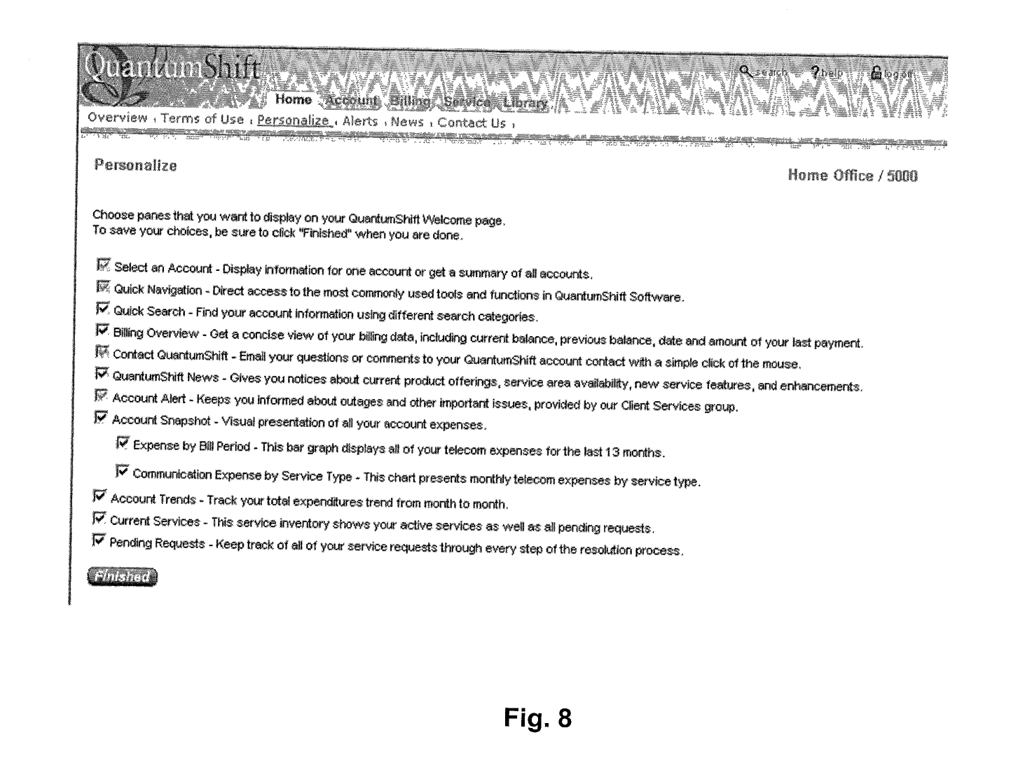

The account snapshot section is a graphical view of a customer's account trends and expenses. For example, a total expense trend report can be included in the account snapshot, enabling the customer to see account expenses over the last twelve months. A total charges by location report can also be included in the account snapshot, showing charges for each location. For more detail, the customer can select or click on any report. Other reports can be included in the account snapshot and the customer can be allowed to personalize which reports are displayed in the user interface, as explained below with reference to FIG. 8.

The account trends section provides a quick view of prior expenses for a product compared to current expenses. The account trends field can list various types of products, such as calling card, long distance, toll free, etc., along with current expenses and a percentage change from one period to the next. Other products can include local service, T1 service, frame relay service, private line service, cellular direct, cellular pass through and pager service. The expenses and percentage change in account trends field can be based upon any time period, such as weekly, monthly, or quarterly.

The current services section shows the customer an inventory of all active products, including devices, services, and features. The customer can select among several products as described above. For each product e.g., long distance switched or toll free switched, the customer is shown a number of active products, number of add orders, number of change orders, number of remove orders, and number of repair orders. The customer can easily obtain more detail for any of the products. For example, by clicking on “Long Distance—Switched,” the customer can view the actual inventory of those 224 long distance lines. For further detail, the customer can click on any of those long distance lines and view the details. In this way, the user interface of FIG. 4 provides high level details and allows a customer to quickly navigate to more detailed information. This can be done, for example, by including a link to a more detailed page.

The pending requests section compiles information about service requests, including order number, date, activity, description, and status. This gives the customer up-to-the-minute service tracking as part of the primary user interface. A service request can be submitted by the customer. Alternatively, a service request can be generated automatically in response to an event, such as a network failure or a power outage. For example, notice of such an event could be received from a network monitoring system or from a provider. In response, a service request can be automatically generated. Alternatively, a customer could define a rule for when a service request should be generated. For example, a customer could create a rule that, if a product is not used for three months, a remove request should be generated for that product.

The select an account section is a tool for quick navigation. The customer can arrange his accounts in a hierarchy of accounts by, for example, geographic locations or departments. Using a drop down box, the customer can select an account in the hierarchy, such as San Francisco office or sales department, and all of the information on the user interface will be updated accordingly. Alternatively, the customer can view a summary of any subset of accounts or all of the accounts. A subset of accounts may be, for example, West Coast offices. The present invention allows the customer to define his account structure, or hierarchy. This gives the customer flexibility and control over his account information.

The quick navigation section is another navigation tool, giving a customer a one-step way to get to the most frequently navigated portions of the user interface. Using one or more drop-down lists or menus, the user interface lists the most frequently navigated portions, for example, historical invoices or current invoices, enabling the user to quickly view a portion of the user interface.

The quick search section enables the customer to search for a desired part of the user interface, such as a specific account or a particular service request.

The billing overview section is a snapshot of an online invoice, including any past due amount, current charges, balance due, last payment amount, last payment method, billing contact, and year-to-date billing. Also in the billing overview section are links enabling the user to view payment history or view a current invoice. The customer can view this invoice for each account or for all accounts. For example, a customer may receive one invoice for an entire organization but have 300 locations or accounts. Using the billing overview section, the customer can see a billing summary for each of the 300 accounts or for the overall organization.

The contact information section can provide quick links to e-mail information for a customer's account manager or sales contact. Contact information can also provide a means for the customer to provide feedback on the user interface or to submit a trouble ticket.

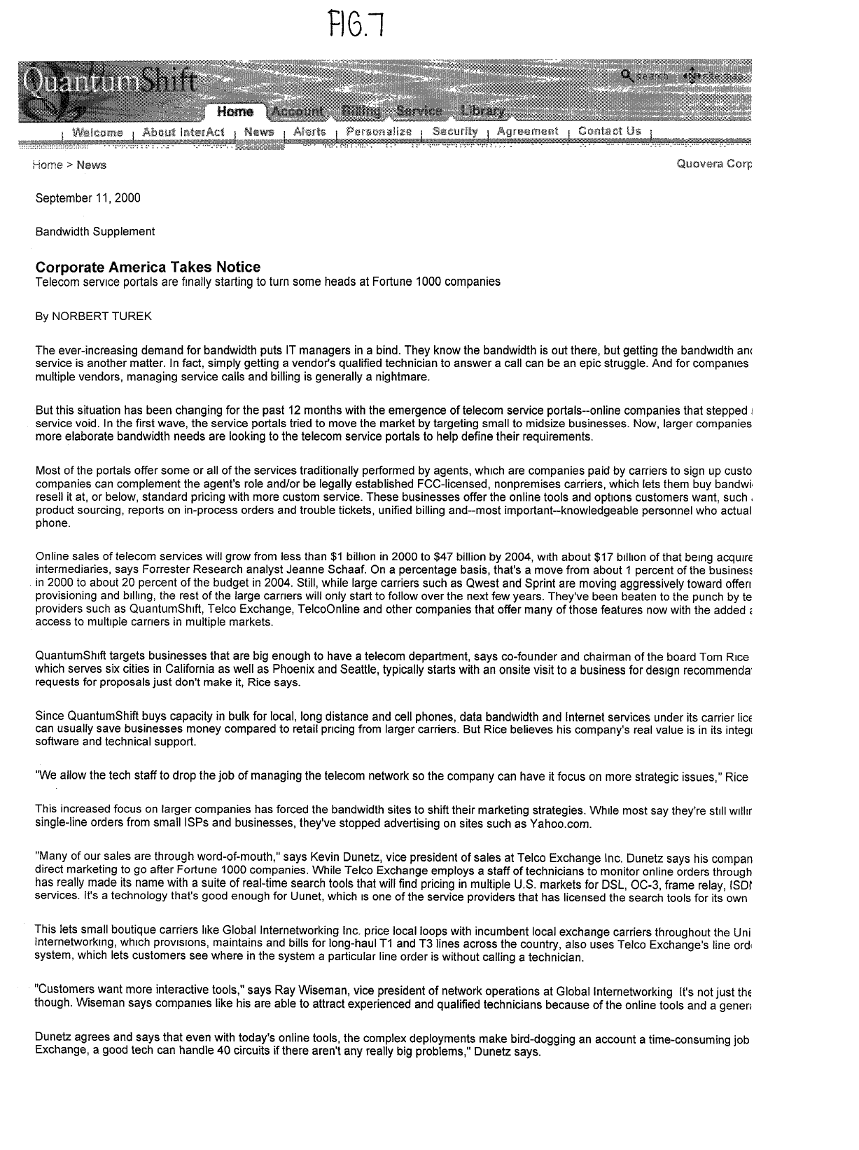

The news section is an improved way to communicate with customers. This section can include links to news items such as new geographical areas to be covered or new product releases. The news section is explained in further detail below with reference to FIG. 7.

The user interface of FIG. 4 provides a single portal containing all the information a customer needs to manage telecommunications products.

The customer can decide which sections make up this initial user interface. For example, the customer can decide which graphs or data he sees. The customer can also select certain individuals in an organization to see different levels of the account information. Additional information can be added to this user interface consistent with the present invention. For example, a real-time map of a customer's network can be displayed with any troubles spots shown graphically.

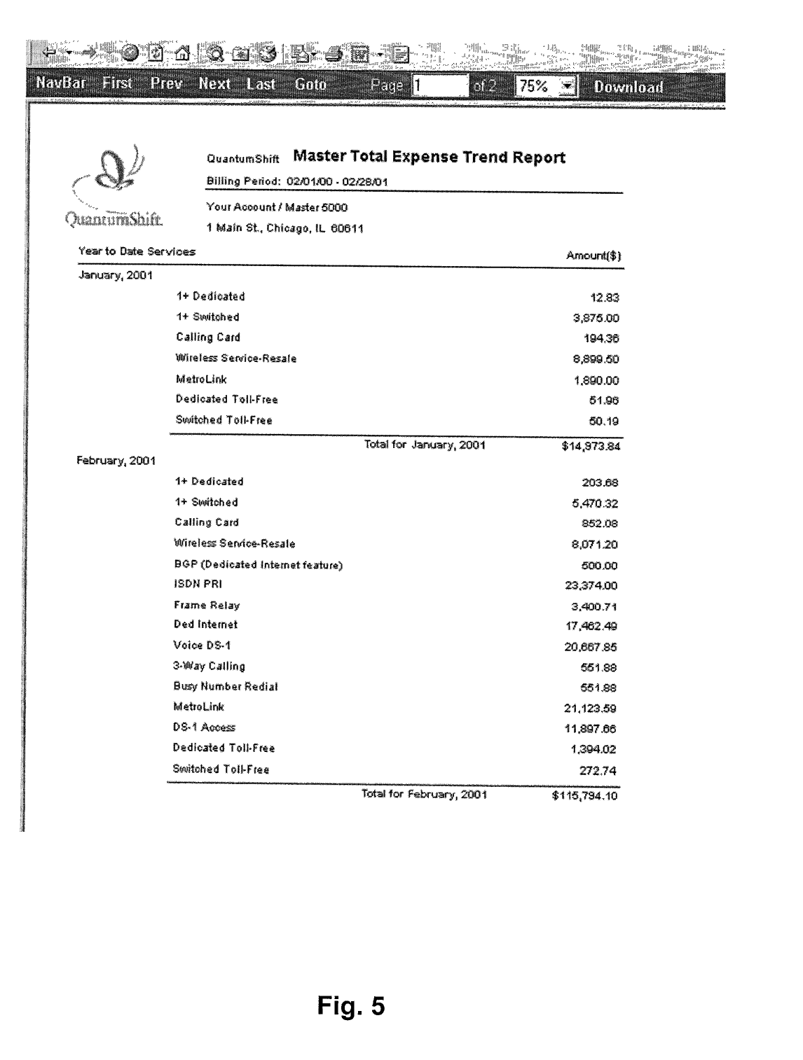

FIG. 5 is a sample user interface depicting a total expense trend report consistent with the present invention. This total expense trend report can be presented to the user when the user clicks on the total expense trend report in the account snapshot section of FIG. 4. The total expense trend report summarizes billing data and expenses over multiple products, such as calling card or pagers, as well as multiple vendors, such as Worldcom and Pacific Bell. The total expense trend report can also present totals on a monthly basis or an annual basis or based on any other time period. Similar reports can be provided for any of the reports included in the account snapshot section of FIG. 4.

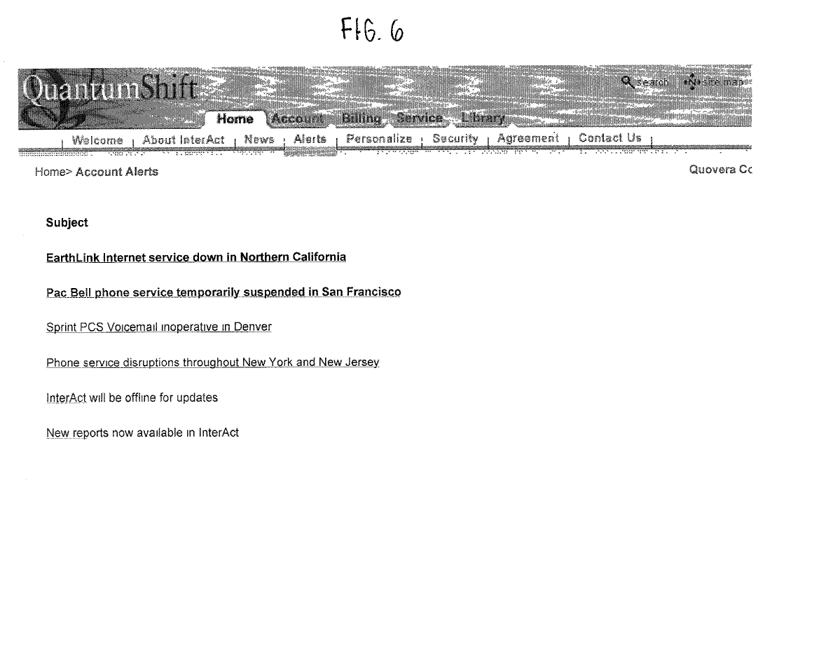

FIG. 6 shows account alerts, which can be accessed when the customer selects the account alerts section of the user interface shown in FIG. 4. The alerts in FIG. 6 can notify a customer when one or more of the customer's products is disrupted or changed. For example, the customer can be notified if Internet service is down in a certain geographical location, or if voice mail is malfunctioning in another geographical location. The account alerts page of FIG. 6 can allow the customer to click on any alert and receive a full report detailing the alert status and any actions taken to remedy the problem.

FIG. 7 is a detailed news page presented when a customer clicks on a title in the news section of the user interface of FIG. 4. For example, the news reports could be taken from popular publications, Internet news services, or press releases.

FIG. 8 is a user interface for enabling a customer to personalize the appearance of the user interface of FIG. 4. The customer can be given a selection of, for example, eleven different panes to be displayed on the user interface of FIG. 4. As shown in FIG. 8, all eleven panes have been selected and are therefore shown on FIG. 4. These panes include select an account, quick navigation, quick search, billing overview, contact information, industry news, account alert, account snapshot, account trends, current services, and pending requests. It will be clear to one of skill in the art that fewer or more than content panes could also be utilized consistent with the present invention. To provide added flexibility, each pane selection can include sub-choices as shown by the account snapshot pane, consisting of two choices: expense by bill period and communication expense by service type.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of presenting account information to a customer on a browser running on a client computer, comprising the steps of:
collecting product information relating to a set of products provided by a plurality of providers to the customer;
receiving a request for a document containing product information about the set of products provided to the customer, the request including a designation of at least one account in a hierarchy of customer accounts;
combining the product information relating to the set of products to create the document with an account statement for the customer; and
displaying the document on the browser on the client computer, the document containing the account statement.

2. The method of claim 1, further comprising the steps of:
receiving an update request for an updated document containing product information about an updated set of products provided to the customer;
combining the product information relating to the updated set of products to create the updated document with an updated account statement for the customer; and
displaying the updated document on the browser on the client computer, the updated document containing the updated account statement.

3. The method of claim 1, wherein the designation of at least one account in the hierarchy of customer accounts designates all accounts of the customer.

4. The method of claim 1, wherein the designation of at least one account in the hierarchy of customer accounts designates a subset of accounts of the customer.

5. The method of claim 1, wherein the designation of at least one account in the hierarchy of customer accounts designates one account of the customer.

6. The method of claim 1, wherein the hierarchy of customer accounts is defined by the customer.

7. The method of claim 1, wherein the request further includes a request for account alerts corresponding to the set of products.

8. The method of claim 1, wherein the request further includes a request for account snapshots corresponding to the set of products.

9. The method of claim 1, wherein the request further includes a request for account trends corresponding to the set of products.

10. The method of claim 1, wherein the request further includes a request for service requests corresponding to the set of products.

11. The method of claim 1, wherein the request further includes a request for a billing overview corresponding to the set of products.

12. The method of claim 1, wherein the request further includes a request for usage data corresponding to the set of products.

13. The method of claim 1, wherein the request further includes a request for operational status data corresponding to the set of products.

14. The method of claim 1, wherein the request further includes a request for real-time data corresponding to the set of products.

15. A method for presenting telecommunications account information to a customer, the customer using a program running on a wireless device, comprising the steps of:
collecting product information relating to a set of telecommunications products provided by a plurality of providers to the customer;
receiving a request for a document containing product information about the set of telecommunications products provided to the customer, the request using a wireless protocol;
combining the product information relating to the set of telecommunications products to create the document with an account statement for the customer; and
displaying the document on the wireless device using the wireless protocol, the document containing the account statement.

16. The method of claim 15, further comprising the steps of:
receiving an update request for an updated document containing product information about an updated set of telecommunications products provided to the customer, the update request using the wireless protocol;
combining the product information relating to the updated set of telecommunications products to create the updated document with an updated account statement for the customer; and
displaying the updated document on the wireless device using the wireless protocol, the updated document containing the updated account statement.

17. The method of claim 15, wherein the wireless protocol is Wireless Application Protocol (WAP).

18. The method of claim 15, wherein the wireless device is a wireless phone.

19. The method of claim 15, wherein the wireless device is a personal digital assistant.

20. The method of claim 15, wherein the wireless device is a pager.

21. A method of presenting account information to a customer on a program running on a wireless device, comprising the steps of:
collecting product information relating to a product provided by a provider to the customer;
receiving a request for a document containing product information about the product provided to the customer, the request including a designation of at least one account in a hierarchy of customer accounts and the request using a wireless protocol;
combining the product information relating to the product to create the document with an account statement for the customer; and
displaying the document on the wireless device using the wireless protocol, the document containing the account statement.

22. The method of claim 21, further comprising the steps of:
receiving an update request for an updated document containing product information about an updated set of products provided to the customer, the update request using the wireless protocol.
combining the product information relating to the updated set of products to create the updated document with an updated account statement for the customer; and
displaying the updated document on the wireless device using the wireless protocol, the updated document containing the updated account statement.

23. The method of claim 21, wherein the designation of at least one account in the hierarchy of customer accounts designates all accounts of the customer.

24. The method of claim 21, wherein the designation of at least one account in the hierarchy of customer accounts designates a subset of accounts of the customer.

25. The method of claim 21, wherein the designation of at least one account in the hierarchy of customer accounts designates one account of the customer.

26. The method of claim 21, wherein the hierarchy of customer accounts is defined by the customer.

27. The method of claim 21, wherein the request further includes a request for account alerts corresponding to the set of products.

28. The method of claim 21, wherein the request further includes a request for account snapshots corresponding to the set of products.

29. The method of claim 21, wherein the request further includes a request for account trends corresponding to the set of products.

30. The method of claim 21, wherein the request further includes a request for service requests corresponding to the set of products.

31. The method of claim 21, wherein the request further includes a request for a billing overview corresponding to the set of products.

32. The method of claim 21, wherein the request further includes a request for usage data corresponding to the set of products.

33. The method of claim 21, wherein the request further includes a request for operational status data corresponding to the set of products.

34. The method of claim 21, wherein the request further includes a request for real-time data corresponding to the set of products.

35. The method of claim 21, wherein the wireless protocol is Wireless Application Protocol (WAP).

36. The method of claim 21, wherein the wireless device is a wireless phone.

37. The method of claim 21, wherein the wireless device is a personal digital assistant.

38. The method of claim 21, wherein the wireless device is a pager.

39. A user interface for presenting account information to a customer on a browser running on a client computer, comprising:
a first component including a set of account alerts corresponding to one or more products of the customer, the products provided by one of a plurality of providers;
a second component including a set of account snapshots for presenting data about the one or more products;
a third component including a summary of account trends indicating current and prior costs corresponding to the one or more products;
a fourth component including a list of the one or more products;
a fifth component including a list of service requests for one or more of the products and the status of each of the listed service requests;
a sixth component enabling the customer to select a subset of the products;
a seventh component enabling the customer to select a new user interface to be displayed;
an eighth component enabling the customer to search the user interface;
a ninth component including a billing overview for the one or more products;
a tenth component including contact information for a service representative; and
an eleventh component including news items related to the one or more products.

40. The user interface of claim 39, wherein the subset selected by the customer using the sixth component dictates the data displayed in the first, second, third, fourth, fifth, and eighth components.

41. The user interface of claim 39, wherein the subset of products selected by the customer using the sixth component includes all products provided to the customer by the plurality of providers.

42. The user interface of claim 39, wherein the user interface is displayed on a single screen on the client computer.

43. A user interface for presenting telecommunications account information to a customer having a hierarchy of telecommunications accounts defined by the customer, the user interface presented to the customer on a browser running on a client computer, comprising:
an account input component for receiving a designation of an account in the hierarchy of telecommunications accounts;
an information type input component for receiving a type of information to be displayed; and
a display component for displaying the type of information corresponding to the designated at least one account received by the account input component.

44. The user interface of claim 43, wherein the designation of at least one account designates all of the accounts in the hierarchy of telecommunications accounts.

45. The user interface of claim 43, wherein the designation of at least one account designates a subset of the accounts in the hierarchy of telecommunications accounts.

46. The user interface of claim 43, wherein the designation of at least one account designates one of the accounts in the hierarchy of telecommunications accounts.

47. The user interface of claim 43, wherein the type of information to be displayed includes an account alert.

48. The user interface of claim 43, wherein the type of information to be displayed includes an account snapshot.

49. The user interface of claim 43, wherein the type of information to be displayed includes account trends.

50. The user interface of claim 43, wherein the type of information to be displayed includes a service request.

51. The user interface of claim 43, wherein the type of information to be displayed includes a billing overview.

52. A method for presenting communications account information to a customer having a plurality of accounts, comprising the steps of:
receiving a request for a communications product from the customer, the request including a designation of at least one of the plurality of accounts, sending the request to one of a plurality of providers for provision of the communications product, and
collecting product information relating to the communications product from the provider of the communications product;
combining the product information relating to the communications product to create an account statement for the customer; and
displaying the account statement to the customer.

53. The method of claim 52, wherein the product information relating to the communications product includes a status of providing the communications product to the customer.

54. The method of claim 52, wherein the product information relating to the communications product includes costs due to the provider for provision of the communications product to the customer.

55. The method of claim 52, wherein the product information relating to the communications product includes a status of removing the communications product from the customer.

56. The method of claim 52, wherein the product information relating to the communications product includes a status of changing the communications product.

57. The method of claim 53, wherein the account statement includes the status of providing the communications product to the customer.

58. The method of claim 54, wherein the account statement includes the costs due to the provider.

59. The method of claim 55, wherein the account statement includes the status of removing the communications product from the customer.

60. The method of claim 56, wherein the account statement includes the status of changing the communications product.

61. The method of claim 52, wherein the account statement corresponds to a plurality of accounts.

62. The method of claim 52, wherein the account statement corresponds to a plurality of communications products.

63. The method of claim 52, further comprising the steps of:
receiving a service request relating to the communications product from the customer; and
sending the service request to the provider that provides the communications product to the customer.

64. The method of claim 63, wherein the account statement includes a status of the service request.

65. The method of claim 63, wherein the service request is an add order.

66. The method of claim 63, wherein the service request is a change order.

67. The method of claim 63, wherein the service request is a remove order.

68. The method of claim 63, wherein the service request is a repair order.

69. The method of claim 63, wherein the service request is a query.

70. The method of claim 52, further comprising the steps of:
generating a service request relating to the communications product for the customer in response to an event;
sending the service request to the provider that provides the communications product to the customer; and
notifying the customer of the service request.

71. The method of claim 70, wherein the event is a failure of the communications product.

72. The method of claim 70, further comprising the step of:
receiving notice of the event from a network monitoring system.

73. The method of claim 70, further comprising the step of:
receiving notice of the event from the provider that provides the communications product to the customer.

74. The method of claim 70, wherein the service request is an add order.

75. The method of claim 70, wherein the service request is a change order.

76. The method of claim 70, wherein the service request is a remove order.

77. The method of claim 70, wherein the service request is a repair order.

78. The method of claim 70, wherein the service request is a query.
